(19) United States
(12) Patent Application Publication
(10) Pub. No.: US 2008/0235289 A1
(43) Pub. Date: Sep. 25, 2008

(54) Method and device for managing unstructured data

(75) Inventors: David Christopher Carnes, Minneapolis, MN (US); Nicholas Jeffrey Longtin, Minneapolis, MN (US)

Correspondence Address: David C. Carnes;c/o Arcstone, Suite 200, 104 West Franklin Ave., Minneapolis, MN, 55404, US

(73) Assignee: Wonderworks LLC

(21) Appl. No.: 12/008,031

(22) Filed: Jan. 8, 2008

Related U.S. Application Data
(63) Continuation-in-part of application No. 11/148,757, filed on Jun. 9, 2005.
(60) Provisional application No. 60/676,192, filed on Apr. 29, 2005.

(51) Int. Cl. G06F 17/30

(52) U.S. Cl. 707/200; 707/E17.01

(57) ABSTRACT

Methods and systems for managing unstructured data. Embodiments involve providing a portion of data within a client in the networked computing system. A profile is created that is associated with the portion of data, the profile having at least a first tag and a user identifier. The portion of data and the profile are transmitted from the client to a server in the networked computing system. The portion of data, for example, a file, and the first tag are automatically stored into a data structure, such as a file and an associated database, on the server in response to receipt of the portion of data and the profile by the server. The data structure is subsequently identified in response to a query by the user seeking data associated with the first tag.

### RELATED PATENT DOCUMENTS

This application is a continuation-in-part of U.S. patent application Ser. No. 11/148,757, filed Jun. 9, 2005, which claims the benefit of Provisional Patent Application Ser. No. 60/676,192, filed on Apr. 29, 2005, to which priority is claimed pursuant to 35 U.S.C. §119(e), both of which are hereby incorporated herein by reference.

### FIELD OF THE INVENTION

The invention relates generally to computer file storage systems and methods, and more particularly to computer systems and methods that manage unstructured data.

### BACKGROUND OF THE INVENTION

Individual disk capacity has grown at roughly seventy percent (70%) per year from 1994 to 2004 in the United States (US). Typically, consumers use their computers primarily for communication and organizing personal information, whether it is traditional personal information manager (PIM) style data or media such as digital music or photographs. The amount of digital content, and the ability to store the raw bytes, has increased tremendously; however, the methods available to consumers for organizing and unifying this data has not kept pace. Knowledge workers spend considerable time managing and sharing information, and some studies estimate that knowledge workers in the US in 2004 spent 15-25% of their time on non-productive information related activities.

Traditional approaches to the organization of information in computer systems have centered on the use of file-folder-and-directory-based systems to organize groups of files into directory hierarchies of folders based on an abstraction of the physical organization of the storage medium used to store the files. The Multics operating system, developed during the 1960s, can be credited with pioneering the use of the files, folders, and directories to manage storable units of data at the operating system level. Specifically, Multics used symbolic addresses within a hierarchy of files (thereby introducing the idea of a file path) where physical addresses of the files were not transparent to the user (applications and end-users). This file system was entirely unconcerned with the file format of any individual file, and the relationships amongst and between files was deemed irrelevant at the operating system level (that is, other than the location of the file within the hierarchy).

Since the advent of Multics, storable data has been organized into files, folders, and directories at the operating system level. These files generally include the file hierarchy itself (the “directory”) embodied in a special file maintained by the file system. This directory, in turn, maintains a list of entries corresponding to all of the other files in the directory and the nodal location of such files in the hierarchy (herein referred to as the folders).

However, while providing a reasonable representation of information residing in the computer's physical storage system, a file system is nevertheless an abstraction of that physical storage system, and therefore utilization of the files requires a level of indirection (interpretation) between what the user manipulates (units having context, features, and relationships to other units) and what the operating system provides (files, folders, and directories). Consequently, users (applications and/or end-users) have no choice but to force portions of data into a file system structure even when doing so is inefficient, inconsistent, or otherwise undesirable. Moreover, existing file systems know little about the structure of data stored in individual files and, because of this, most of the information remains locked up in files that may only be accessed (and comprehensible) to the applications that wrote them. Consequently, this lack of mechanisms for managing information leads to the creation of silos of data. Because most existing file systems utilize a nested folder metaphor for organizing files and folders, as the number of files increases the effort necessary to maintain an organization scheme that is flexible and efficient becomes quite daunting.

Several unsuccessful attempts to address the shortcomings of file systems have been made in the past. Object-oriented database (OODB) systems have been made, but these attempts, while featuring strong database characteristics and good non-file representations, were not effective in handling file representations and could not replicate the speed, efficiency, and simplicity of the file and folder based hierarchical structure at the hardware/software interface system level.

### SUMMARY OF THE INVENTION

The present invention is directed to systems and methods for managing unstructured data. Embodiments of methods of the present invention may involve providing a portion of data within a client in the networked computing system. A profile is created that is associated with the portion of data, the profile having at least a first tag and a user identifier. The portion of data and the profile are transmitted from the client to a server in the networked computing system. The portion of data and the first tag are automatically stored into a data structure on the server in response to receipt of the portion of data and the profile by the server. The data structure is subsequently identified in response to a query by the user seeking data associated with the first tag.

According to another embodiment, a system includes a client configured to provide a portion of data, and to associate the portion of data with a profile, the profile having a first tag and a user identifier. A server is communicatively coupled to the client, the server configured to receive the portion of data and the profile from the client, and to automatically store the portion of data and the first tag into a data structure on the server in response to receipt of the portion of data and the profile by the server. The server is further configured to identify the data structure in response to a query by the user seeking data associated with the first tag.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a block diagram of a profile based data management system for managing unstructured data in accordance with embodiments of the present invention;

FIG. 2 is a block diagram of file management using a profile based data management system versus a typical file management system of files and folders;

FIG. 3 is a block diagram illustrating a profile associated with a portion of data in accordance with embodiments of the present invention;

FIG. 4 is a flowchart of a method of managing unstructured data in accordance with embodiments of the present invention;

FIG. 5 is an example of a user interface illustrating unstructured data having associated profiles used to manage unstructured data in accordance with embodiments of the present invention;

FIG. 6 is an example of a user interface illustrating unstructured data having associated profiles used to manage unstructured data in accordance with embodiments of the present invention;

FIG. 7 is an example of a user interface illustrating unstructured data having associated profiles used to manage unstructured data in accordance with embodiments of the present invention;

FIG. 8 is an example of a user interface illustrating unstructured data having associated profiles used to manage unstructured data in accordance with embodiments of the present invention;

FIG. 9 is an example of a user interface illustrating unstructured data having associated profiles used to manage unstructured data in accordance with embodiments of the present invention;

FIG. 10 is an example of a user interface illustrating unstructured data having associated profiles used to manage unstructured data in accordance with embodiments of the present invention;

FIG. 11 is an example of a user interface illustrating unstructured data having associated profiles used to manage unstructured data in accordance with embodiments of the present invention;

FIG. 12 is an example of a user interface illustrating unstructured data having associated profiles used to manage unstructured data in accordance with embodiments of the present invention;

FIG. 13 is an example of a user interface illustrating unstructured data having associated profiles used to manage unstructured data in accordance with embodiments of the present invention;

FIG. 14 is an example of a user interface illustrating unstructured data having associated profiles used to manage unstructured data in accordance with embodiments of the present invention;

FIG. 15 is an example of a user interface illustrating unstructured data having associated profiles used to manage unstructured data in accordance with embodiments of the present invention; and

FIG. 16 is a block diagram of an embodiment illustrating managing unstructured data in accordance with embodiments of the present invention.

While the invention is amenable to various modifications and alternative forms, specifics thereof have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION OF VARIOUS EMBODIMENTS

The present invention is believed to be applicable to a variety of systems and approaches involving management of unstructured data. For example, methods in accordance with present invention may be related to self-referencing applications, where both the client and server exist on a single computer. Aspects of the invention disclosed below are described in the context of a client-server relationship. While the present invention is not necessarily limited to client-server applications, an appreciation of various aspects of the invention is best gained through a discussion of examples in such an environment. However, point-to-point (P2P) systems or other arrangements for purposes herein shall be considered as variations of a client-server system. For example, in a P2P system involving two data processing systems, one system may be considered as the client, and the other system may be considered as the server, without departing from the scope of the present invention.

In the following description of the illustrated embodiments, references are made to the accompanying drawings, which form a part hereof, and in which are shown by way of illustration, various embodiments by which the invention may be practiced. It is to be understood that other embodiments may be utilized, and structural and functional changes may be made without departing from the scope of the invention.

Methods, devices and systems in accordance with the present invention may include one or more of the features, structures, methods, or combinations thereof described herein. It is intended that methods, devices and systems in accordance with the present invention need not include all of the features and functions described herein, but may be implemented to include selected features and functions that provide for useful structures and/or functionality.

As data volume increases, such as with a large number of files, managing the data becomes increasingly burdensome. For example, during product development cycles, many projects, research documents, spreadsheets, reports, and other data may be generated. Typically this data is stored in a file structure, such as by using directories, subdirectories, and files. Large volumes of data often make it difficult to retrieve a desired portion of data when this structure is utilized. A user may ask such questions as “What did I do with that proposal last year? What folder did I put it in?”

Research into worker efficiency suggests that the average knowledge worker may spend as much as 2.5 hours per day panning for information nuggets in unstructured sources like web pages and document files, even though many of those pages and files may be their own, when working within the file structure system described above. Typically, 85% of the data in an organization may be unstructured (not in a database). The amount of unstructured data in an average business may double every three months.

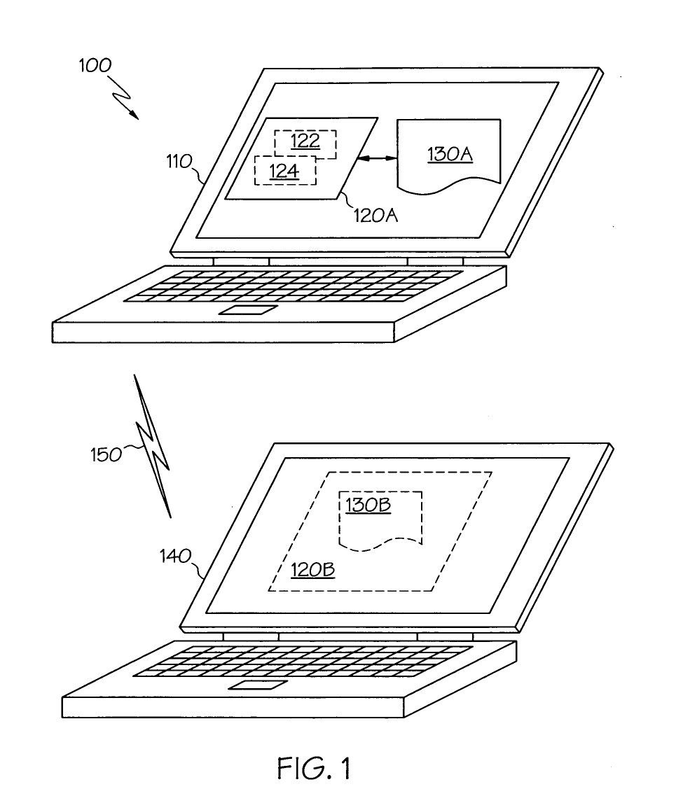

FIG. 1 is a block diagram of a profile based data management system 100 for managing unstructured data in accordance with embodiments of the present invention. The embodiment of the present invention illustrated in FIG. 1 is directed to the profile based data management system 100 useful for managing unstructured data, such as word files, spreadsheets, pictures, documents, video data, email, web addresses, audio files, or other unstructured data. A portion of data 130A is provided within a client 110 in profile based data management system 100. A profile 120A is created that is associated with the portion of data 130A, the profile 120A having at least a first user defined label 122 and a user identifier 124. The portion of data 130A and the profile 120A are transmitted from the client 110 to a server 140 in the profile based data management system 100. The portion of data 130A, for example, a file, and the first user defined label 122 are automatically stored into a data structure 120B, such as a file 130B and the information contained in the profile 120A, on the server 140 in response to receipt of the portion of data 130A and the profile 120A, or the tags associated with the profile 120, by the server 140. The data structure 120B is subsequently identified in response to a query by the user seeking data associated with the first user defined label 122, as will be illustrated in more detail below.

One example of the profile 120A is herein designated as a WONDERFILE, a trademark of Wonderworks LLC, Minneapolis, Minn. Wonderworks provides an online service that, in one example embodiment, integrates with popular electronic messaging platforms, such as MICROSOFT OUTLOOK (a Trademark of Microsoft Inc., Redmond, Wash.) and saves individuals and teams valuable time by making it faster and easier to find, share and manage digital files and information in accordance with embodiments of the present invention. For example, one or more profiles may be used to backup data, share files, store and search files, date/time stamp the actual time the file was uploaded, access files from any Internet connected computer, keep track of important files and information, store files so other people can find them, find files associated with user queries, and perform other data management activities as disclosed herein. In a further example embodiment of using a profile to organize web pages, a profile based data management system can label and save web addresses (URLs), and find what is needed again, quickly.

Other embodiments of the present invention are directed to a hybrid data management system including a digital file library, knowledge base, and collaboration platform. The data management system improves upon known file management models, using a label oriented design and electronic messaging integration that makes storing, sharing, tracking and archiving many kinds of files, in many formats, simple and efficient, as will be described further below.

Profile based data management systems and methods provide users with the ability to manage and share many kinds of files. Files may be loaded, for example, using a website or electronic messaging. Files can be loaded one at a time or concurrently. Files may be loaded via electronic messaging associated with a profile, herein designated Wondermail, by attaching a profile to an electronic message, for example, and sending the electronic message to a predetermined address designating a server in the data management system.

A profile based data management system uses labels instead of folders to organize files. For example, a profile may provide labels that are automatically added to every file. A non-exhaustive, non-limiting list of labels that may be provided includes: defining the user, company, date uploaded, file type, size information, file type (extension, ASCI/Binary, vendor, for example), file meta (created, updated and accessed for example), extended file meta (author and company, for example), person sending, person company, person IP/Other hardware, network info, person OS/version, other software version information, recipients, associated emails, associated account information, or the like. Wondermail allows users to assign labels and set permissions right in the electronic messaging, eliminating the need to also log into a separate website. Moreover, users can add labels to the file later from the web interface. Labels may be added, edited and deleted by users in a label management section of the server, for example, as will be described further below.

Users of profile based data management systems have the capability to find files using refined search criteria. The user may specify any number of labels they want the “found files” to include, or exclude. Users can also refine a search by defining the date uploaded or edited, file type and keywords. The user can also sort the search results. From the search results list, users may edit labels, permissions, and delete multiple files at a time. Search criteria can be saved for quick access at a later time. By saving the criteria rather than the result, searches are always reflecting the latest database information in accordance with the present invention.

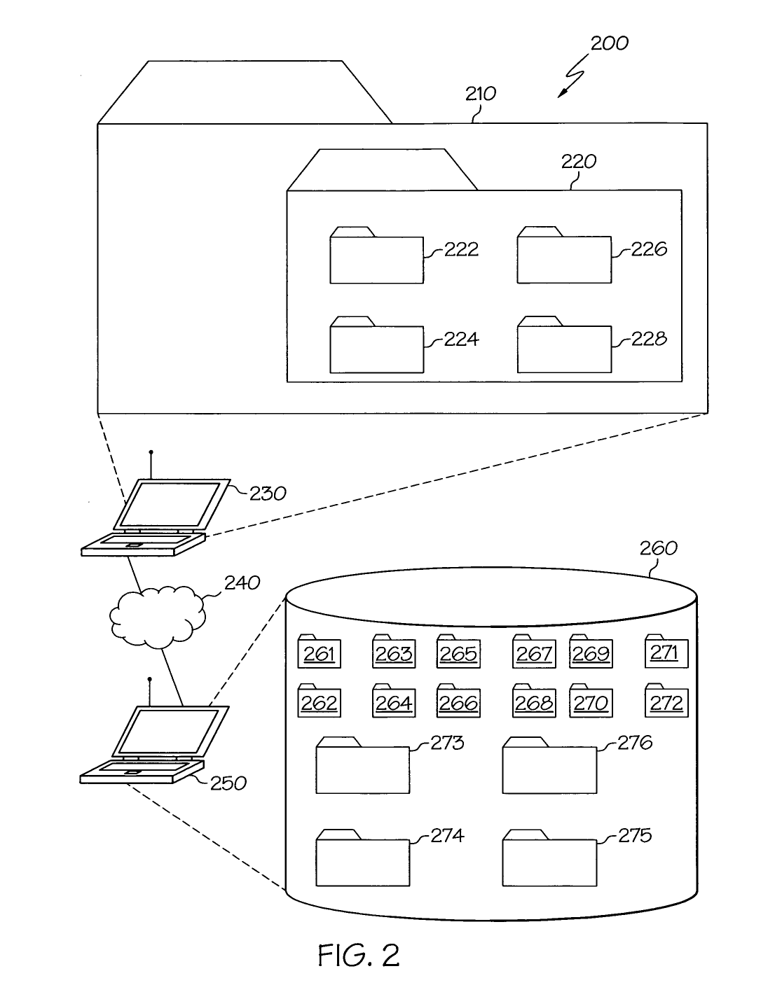

A profile based data management system uses a folder-less, label oriented design. Systems and methods in accordance with the present invention make various types of files accessible from anywhere with an Internet connection. Profile based data management systems may reduce or eliminate the need for disks that can be forgotten or lost. Referring now to FIG. 2, a non-limiting example of a profile based data management system 200 in accordance with the present invention is compared to a typical file-based management system 210, resident on a client system 230. A server 250 is illustrated as configured to use a profile base data management methodology. The server 250 includes memory, designated as a data pile 260. A network system, such as an internet system 240 communicatively connects the client 230 to the server 250, for example using wireless, Ethernet, telephone, or other connection technology.

Typically, in file-based management system 210, files such as, for example, documents, are created and placed in a folder 222, 224, 226, 228 that is located in a directory 220. Folders may be nested in complex arrangements of directories and subdirectories. But basically, a file or document may only be put in one place. This methodology restricts the accessibility of the data. For example, directory and folder based systems create problems if the document belongs in more than one place. If multiple copies of the document are placed into multiple folders, then other problems arise, such as revisions being difficult to manage and memory space being squandered.

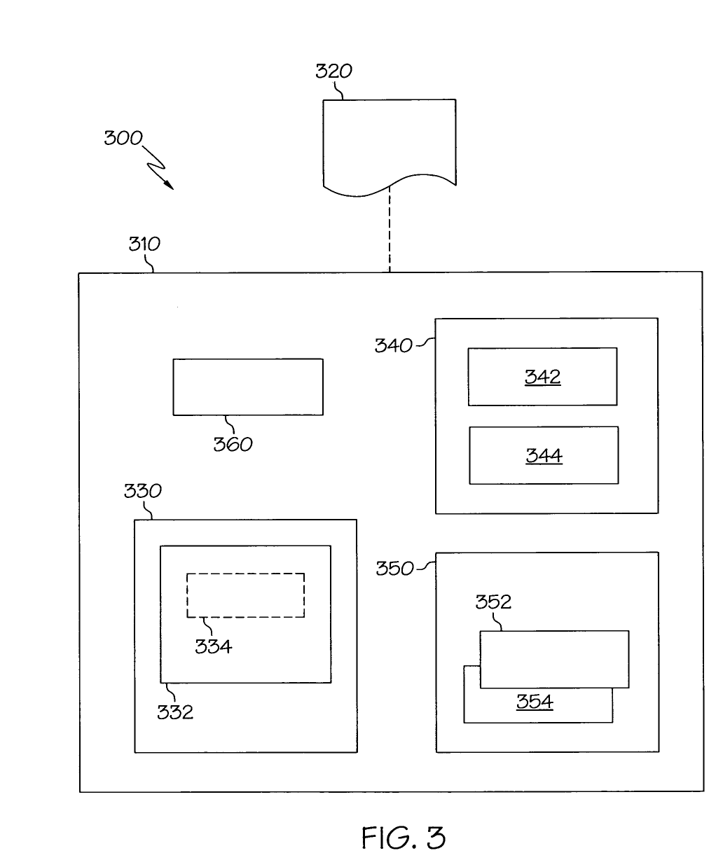

Referring now to both FIG. 2 and FIG. 3, for purposes of clarity and not as limitation, an example will be described referring to an individual, designated as David, working on a plan for marketing white elephants with custom headdresses to high technology and healthcare companies. FIG. 3 is a block diagram illustrating a profile, designated as WONDERFILE 310, associated with a portion of data 320 in accordance with embodiments of the present invention. The portion of data 320, in the particular example, is David's marketing plan, designated as elephantplan.doc. In the folder-based system 210, indecision may occur relative to which file the plan should be placed into. Folders won't solve David's problem, because folders organize data by location. David is forced to choose a single location (one folder) for his file if he only has access to the folder-based system 210. David may choose to place the file in the folder 222, which may be designated as relating to elephants, the folder 224, which may be designated as relating to high technology marketing trends, the folder 226, which may be designated as relating to healthcare marketing trends, and/or folder 228, which may be designated as relating to marketing plans. Regardless of David's choice, the abovementioned problems will arise due to the directory and folder based system 210.

By using the profile based data management system 200, everything goes in the big digital pile 260 that is accessible from many criteria, the criteria resident in the WONDERFILE 310. When the need arises to find an existing portion of data, the profile based data management system 200 finds the file using the criteria, also designated as labels, to recover the portion of data from the pile. The profile based data management system 200 uses labels, instead of folders, to describe and categorize the content of the files. Referring again to the example of David's marketing plan, when David is ready to upload his file, the WONDERFILE 310 (in this particular example embodiment) automatically labels it by a user name 360, a date uploaded 350, and file type 330. For example, David may use pick lists to choose relevant labels (which he can add, delete, group and categorize). If he wants to, he can also add a description 340 and keywords 342, 344. For example, using the above described elephantpan.doc, David may choose a list of keywords to associate with the WONDERFILE 310 to include elephants, high technology marketing trends, healthcare marketing trends, and marketing plans, as well as other keywords and/or phrases. At the same time, he can choose who can, and cannot, access his file. For example, the file type 330 may include one or more designators 332 defining access to the file. Further, a criteria 334 may be added to further limit access, for example allowing some users to view the file only, while other users may edit the file.

The date uploaded 350 may further include a revision tracking 352 and an editing criteria 352 to address some of the problems identified with directory and folder based systems. For example, the editing criteria 352 may be used to check-in and check-out the document for editing, such that only the most recent revision is available to users, and multiple users cannot simultaneously edit a document, leading to revision errors.

After the file is uploaded to the server, anyone with proper permission can search for the file, even without knowing the filename, the folder, or paging through long lists of keyword results. Use of the WONDERFILE 310 finds files by content, not location.

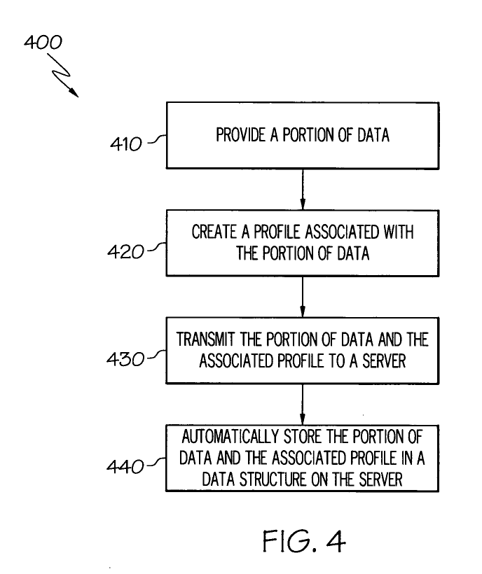

FIG. 4 is a flowchart of a method 400 of managing unstructured data in accordance with embodiments of the present invention. The method 400 involves providing 410 a portion of data within a client in the networked computing system. A profile is created 420 that is associated with the portion of data, the profile having at least a first user defined label and a user identifier. The portion of data and the profile are transmitted 430 from the client to a server in the networked computing system. The portion of data and the first user defined label are automatically stored 440 into a data structure on the server in response to receipt of the portion of data and the profile by the server. The data structure is subsequently identified in response to a query by the user seeking data associated with the first user defined label.

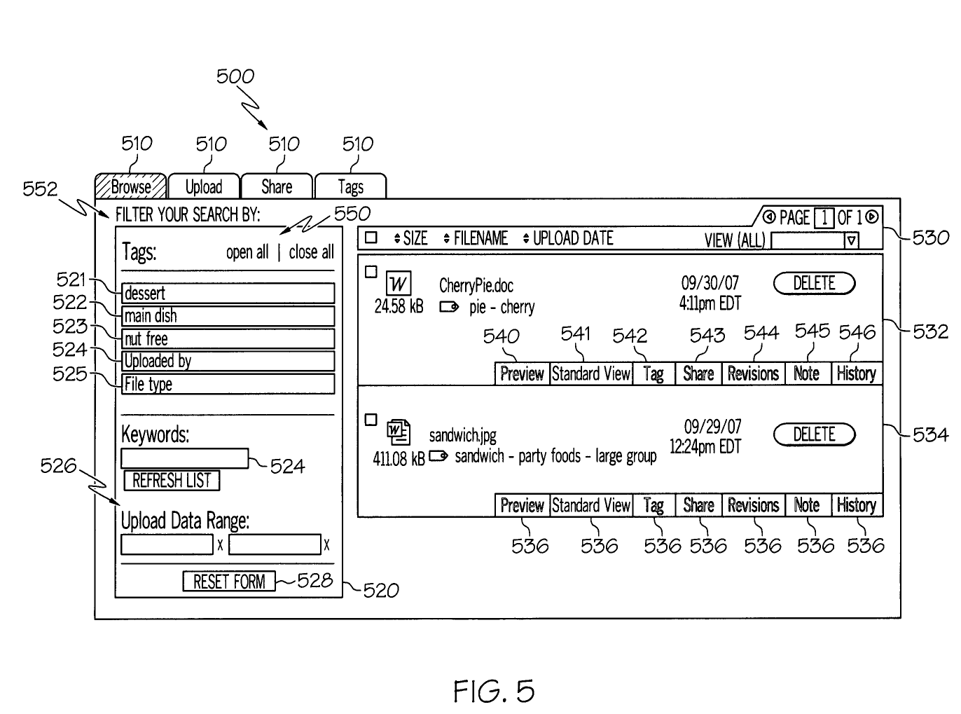

FIG. 5 is an example of a user interface 500 illustrating unstructured data having associated profiles used to manage the unstructured data in accordance with embodiments of the present invention. The user interface 500 includes one or more tabs 510, which may be used to tab between user interface applications such as, for example, browsing, uploading, sharing, and tagging of unstructured data. A first identifier 552 may be used, for example, to identify a first region 520 of the user interface 500 to group functions. The first identifier 552 may be, for example, “Filter your search by:” alerting the user to the activities that may be performed using the grouping of functions within the first region 520.

For purposes of illustration, and not of limitation, the user interface 500 will be described herein to manage unstructured data containing recipes, such as in a cookbook, as an example in accordance with the present invention. The term tag or tags will be used herein to refer to one or more user defined labels, one or more system defined labels, and/or a combination of one or more user defined and system defined labels. The first region 520 may include, for example, a listing of tags such as a dessert tag 521, a main dish tag 522, a nut free tag 523, an uploaded by tag 524, and a file type tag 525. The tags 521-525 may be used to describe attributes of recipes enjoyed by the user. One or more operations 550 may be included within the first region 520 to perform other operations within the first region 520 as desired. The first region 520 is illustrated in FIG. 5 to incorporate one or more soft buttons 528, such as, for example, the soft button 528 providing for a form reset.

A keyword search 524 may be used to search within recipes identified by the first identifier 552 as operated upon by tags 521-525. Further search limitations may be included using, for example, Boolean operators in conjunction with a date range 526, or other desired limitations or operations. For example, the user may select one or more of the tags 521-525, one or more keywords within the keyword search 524, and a date range within the date range 526, which all operate through Boolean AND functions (for example) to identify one or more recipes within a result region 530 of the user interface 500.

The result region 530 illustrated in FIG. 5, for example, includes a first data 532 and a second data 534 in the result region 530. The first data 532 may be, for example, a MS WORD (MS WORD is a registered trademark of Microsoft Corporation, Redmond, Wash.) file containing a cherry pie recipe. The user has associated the cherry pie recipe in the first data 532 with its profile in accordance with the present invention. The first data 532 associates the cherry pie MS WORD document with tags labeled pie and cherry. The second data 534 may be, for example, a scanned recipe from a book or magazine for a sandwich.

The first data 532 and the second data 534 are each illustrated in FIG. 5 to incorporate one or more soft buttons 536, such as, for example, a preview button 540, a standard view button 541, a tag button 542, a share button 543, a revision button 544, a note button 545, and a history button 546. In FIG. 5, for example, the standard view button 541 is illustrated as selected such as by highlighting, changing font size, changing font type, changing color, or other observable change. The soft buttons 536 may be used to invoke alternate views and associated functions operable on their associated profiles in accordance with embodiments of the present invention.

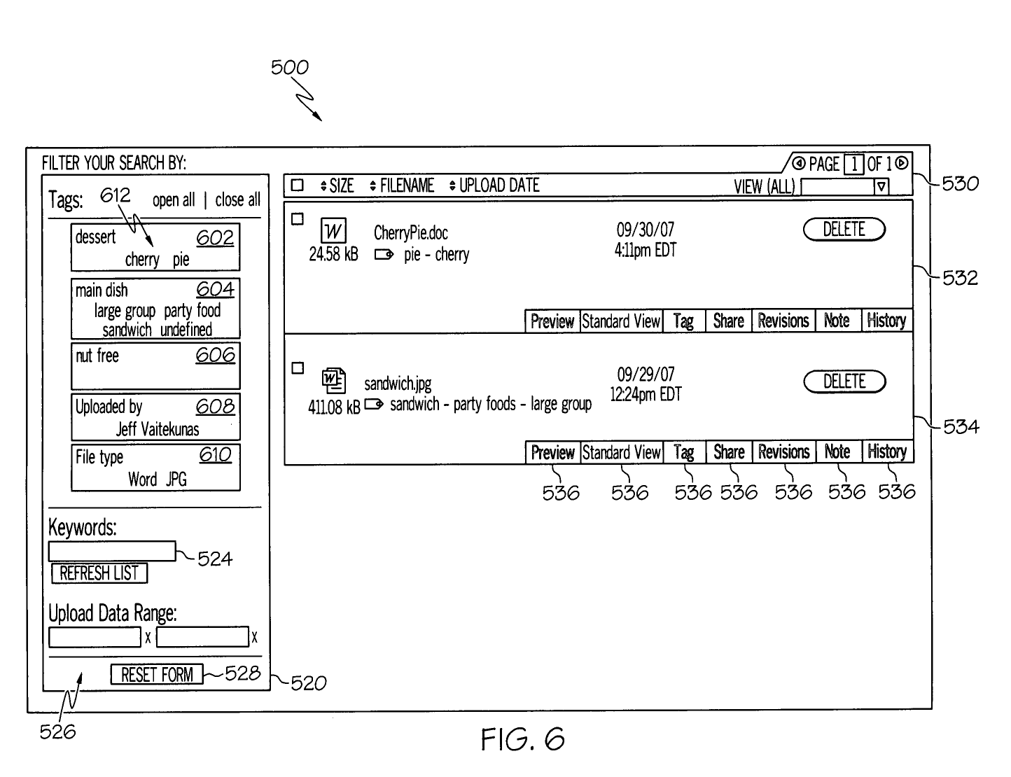

FIG. 6 is an example of the user interface 500 illustrating unstructured data having associated profiles used to manage the unstructured data in accordance with embodiments of the present invention. The first region 520 is illustrated with the tags 521-525 expanded to a dessert category 602, a main dish category 604, a nut free category 606, an uploaded by category 608, and a file type category 610. Expanding the tags 521-525 provides for the user to see, for example, that the dessert category 602 includes a listing 612 including “cherry” and “pie” within the category 602. Categories such as the uploaded by category 608 and the file type category 610 may be created automatically by an unstructured data management system in accordance with the present invention, in addition to user created and defined categories.

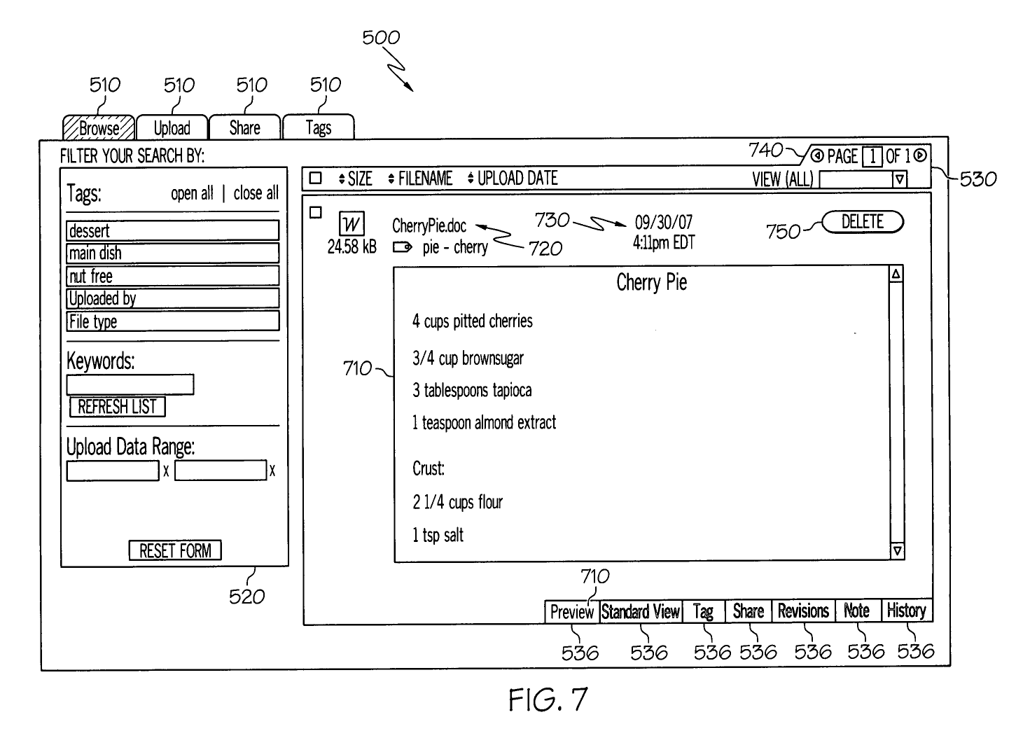

FIG. 7 is an example of the user interface 500 illustrating unstructured data having associated profiles used to manage the unstructured data in accordance with embodiments of the present invention. The soft buttons 536 are illustrated in FIG. 7 with a Preview button 710 selected, thereby expanding the first data 532 illustrated in FIGS. 5 and 6 into the Preview button 710 view illustrated in FIG. 7. The MS WORD data file identified by an icon 720 having a date-stamp 730 is used to provide a preview window 710, offering a preview of the data associated with the icon 720. One or more soft buttons 750 may also be provided to perform operations, such as deleting or other desired operation.

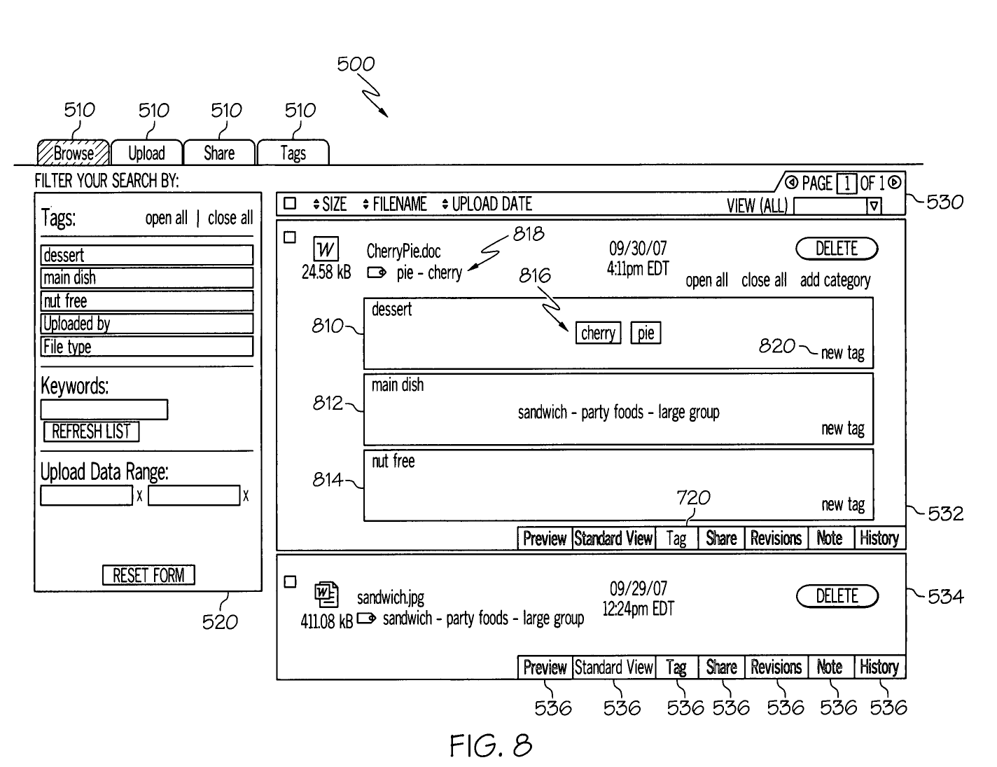

FIG. 8 is an example of the user interface 500 illustrating unstructured data having associated profiles used to manage the unstructured data in accordance with embodiments of the present invention. The first data 532 is illustrated having the tags button 720 selected and the second data 534 is illustrated in the standard view. In this example, selecting the tags button 720 expands a tag window 810, a tag window 812, and a tag window 814 within the first data 532. A tag list 818 is illustrated to be associated with the first data 532, with a highlighted tag set 816 providing the user with the tag profile associated with the first data 532. One or more soft buttons, such as a new tag button 820 may be associated with one or more of the tag windows, to perform operations. For example, the new tag button 820 may be selected to add a new tag to the tag window 810, adding a new user defined association to the dessert category. The tag set 816 may be provided as, for example, a tag cloud, or other suitable arrangement as will be described further below.

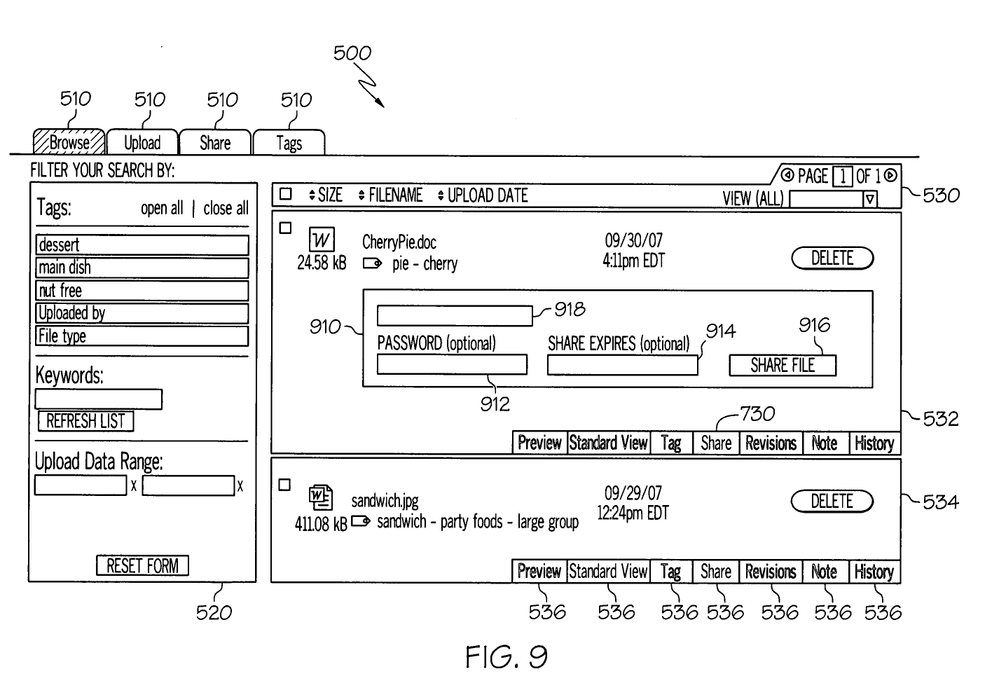

FIG. 9 is an example of the user interface 500 illustrating unstructured data having associated profiles used to manage unstructured data in accordance with embodiments of the present invention. The first data 532 is illustrated having the share button 730 selected and the second data 534 is illustrated in the standard view. In this example, selecting the share button 730 expands a share window 910. The share window 910 may be used, for example, to enable security and users to be defined for sharing the first data 532. For example, a window 918 may be used to add internet addresses to a user's group for the sharing of the first data 532. A password window 912 may be used to enter a password to protect the first data 532 from unauthorized users. A share expires window 914 may be used to define a predetermined date for the expiration of sharing privileges for the first data 532. One or more soft buttons, such as a share file button 916, may be provided to perform operations within the share window 910. For example, the first data 532 may be restricted from sharing with others until the share file soft button 916 is selected, and upon selection of the share file 916 button, any limitations on sharing may be associated with the ability of sharing the first data 532.

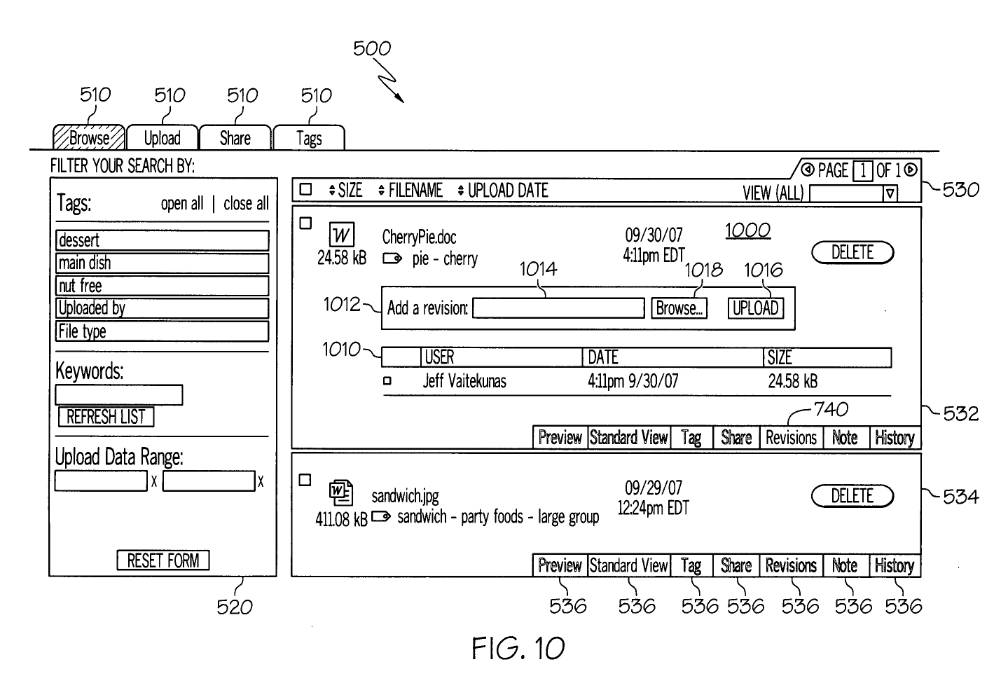

FIG. 10 is an example of the user interface 500 illustrating unstructured data having associated profiles used to manage the unstructured data in accordance with embodiments of the present invention. The first data 532 is illustrated having the revisions button 740 selected and the second data 534 is illustrated in the standard view. In this example, selecting the revisions button 740 expands a revisions window 1000. The revisions window 1000 may be used, for example, to control revisions of documents or to track users who accessed or changed documents. In the example of the revisions window 1000 illustrated in FIG. 10, the cherry pie recipe associated with the first data 532 is observed in a tracking record 1010 to have been created by a user on a particular date, where the file is of a given size. The tracking record 1010 may be updated any time the document is revised, providing a record of who is using the document. An add revision section 1010 may be provided to upload new versions using, for example, an upload soft button 1016. A data window 1014 may be provided to enter revision names, comments, or other information desirable. One or more soft buttons, such as a browse button 1018, may be used to provide other functionality, such as the ability to browse the data structure of a local computer to identify a location for a new revision to add to the revision section 1010.

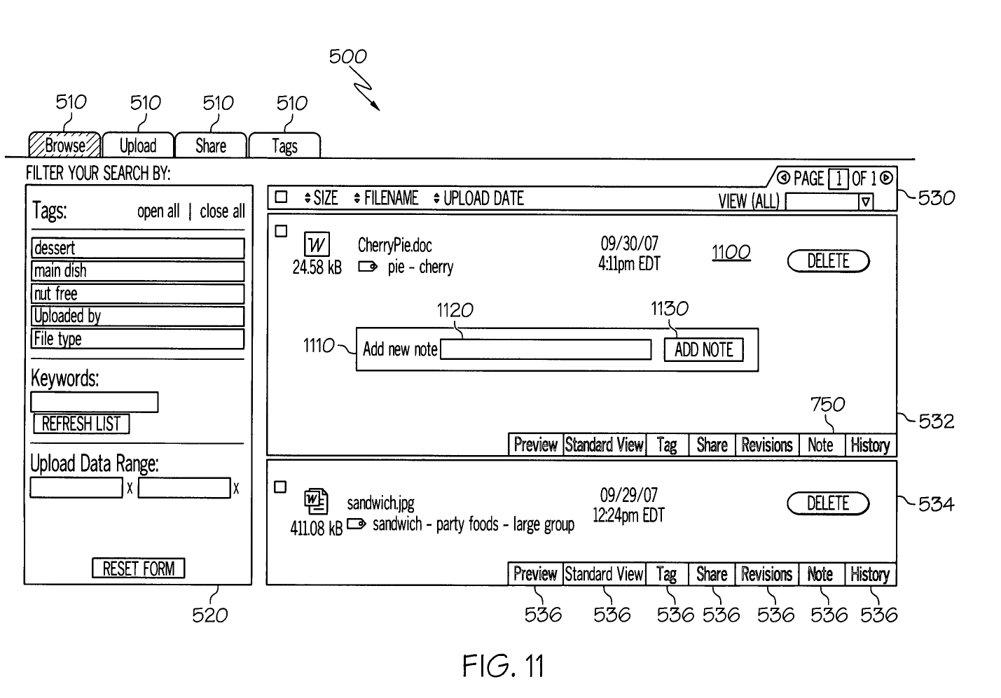

FIG. 11 is an example of the user interface 500 illustrating unstructured data having associated profiles used to manage the unstructured data in accordance with embodiments of the present invention. The first data 532 is illustrated having the notes button 750 selected and the second data 534 is illustrated in the standard view. In this example, selecting the notes button 750 expands a notes window 1100. The notes window 1100 may be used, for example, to add notes to a profile of the first data 532. A notes field 1110 may have a notes entry field 1120 and one or more soft buttons, such as an add note button 1130. Notes may be provided in the notes entry field 1120, for example, to inform shared users of revisions, to identify necessary reviewers, or for other desired activity or informational purpose.

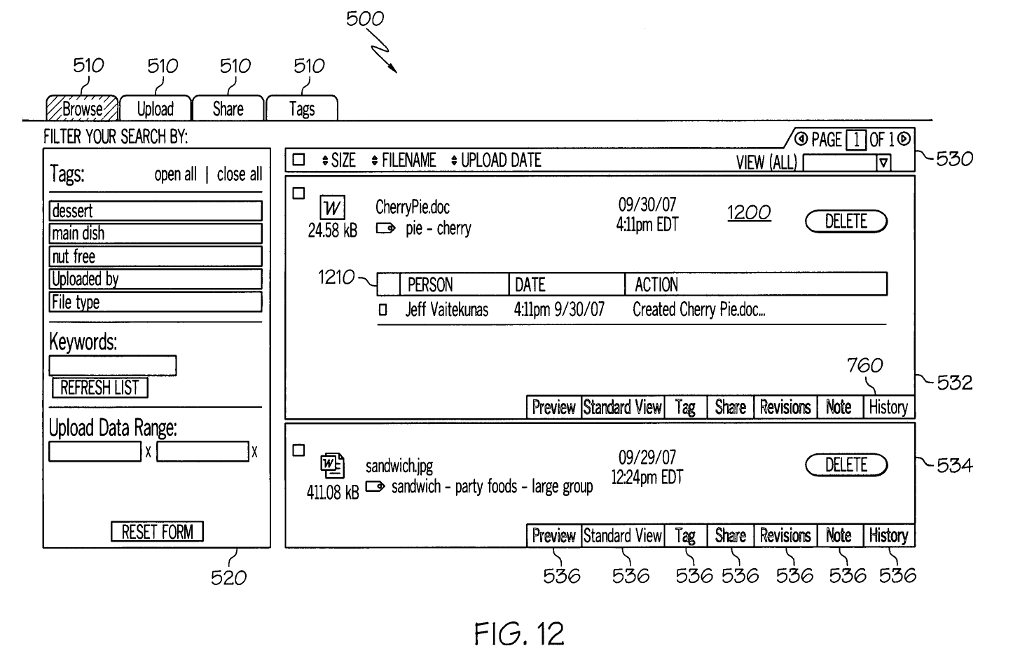

FIG. 12 is an example of the user interface 500 illustrating unstructured data having associated profiles used to manage unstructured data in accordance with embodiments of the present invention. The first data 532 is illustrated having the history button 760 selected and the second data 534 is illustrated in the standard view. In this example, selecting the history button 760 expands a history window 1200. The history window 1200 may be used, for example, to view a history record 1210 showing the history of data associated with the profile of the first data 532. For example, in the history record 1210 the first data 1210 is illustrated as having been created on Sep. 30, 2007. History information may include, for example, editing history, viewing history, backup history, creation history, sharing history, tag history, or other desired history.

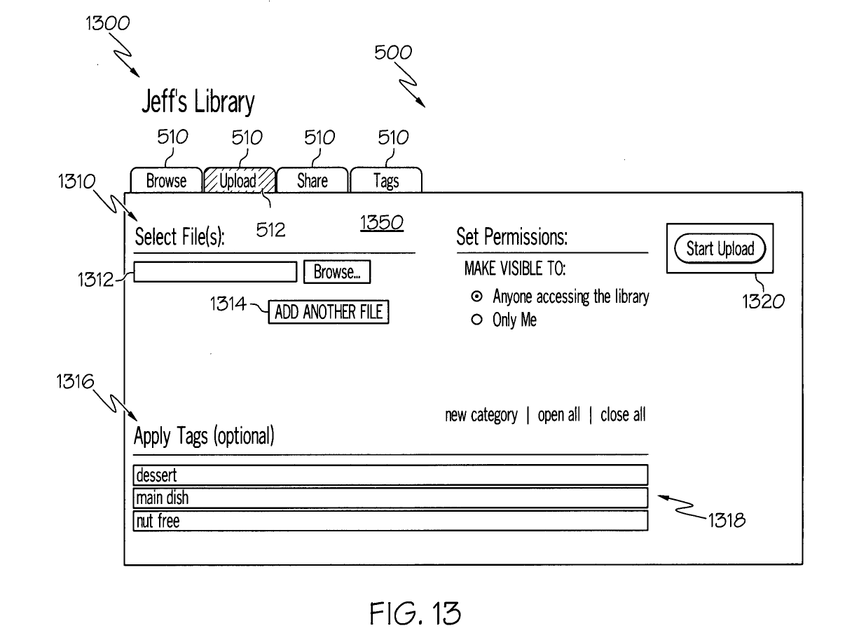

FIG. 13 is an example of the user interface 500 illustrating unstructured data having associated profiles used to manage the unstructured data in accordance with embodiments of the present invention. The tabs 510 identify a tab 512 indicating, in the example illustrated in FIG. 13, operations available to manage uploading of unstructured data. A library definition 1300 defines the library that data provided from an upload interface 1310 will be associated with. A file select input 1312 provides an area for locating a local data file for uploading. One or more soft buttons 1314 may be provided to enhance functionality before uploading in response to pushing an upload button 1320. Additionally, for example, a tag region 1318 may be provided to associate tags with the data intended for upload. The tag region 1318 may have an area title 1316 that describes any additional functionality available from the tag region 1318, for example. The upload interface 1310 may be used, for example, to set permissions for access to uploaded data, to group data, to apply labels such as tags, and other actions in order to create and/or update a profile.

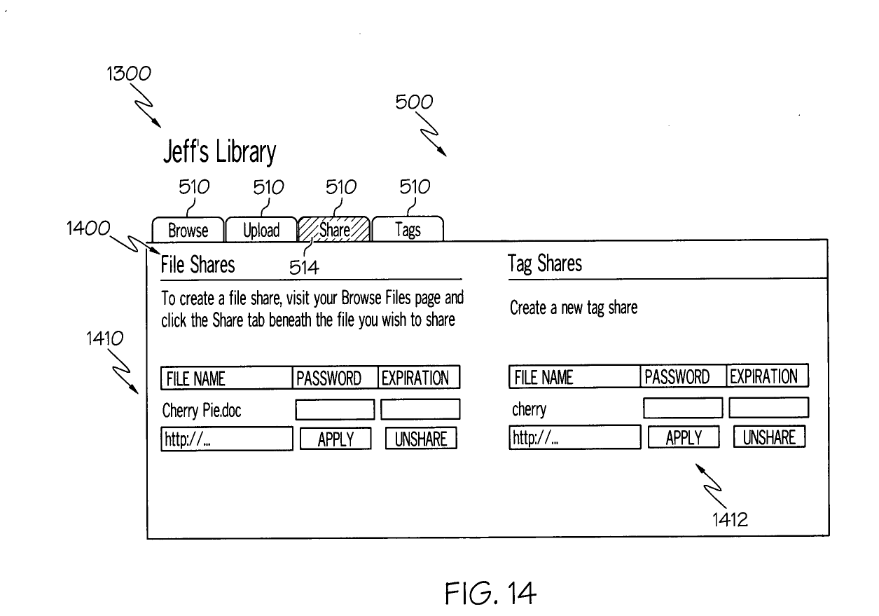

FIG. 14 is an example of the user interface 500 illustrating unstructured data having associated profiles used to manage the unstructured data in accordance with embodiments of the present invention. The tabs 510 identify a tab 514 indicating, in the example illustrated in FIG. 14, operations available to manage sharing of unstructured data. A sharing screen 1400 illustrates, for example, a region 1410 that points to data having a profile associated with the data in accordance with embodiments of the present invention. The region 1410 may include password capabilities, expiration data for limiting the sharing capability associated with the data, and one or more soft buttons for selecting actions or attributes within the region 1410. A tag share region 1412 is illustrated to indicate tags associated with the data indicated by the region 1410, providing operations that may be performed using the tag structure for profiles associated with the data.

For example, tags may be used to share data freely, password protected, and/or limited by date, time, or other desired limitation. For example, a user may have a group of data identified by a particular tag. The user may share the tagged data with others by, for example, emailing a link to the files that are associated with the tag. The shared tag provides access of the group of data to the recipients. As the user adds data associated with the shared tag, the shared data is updated to others sharing the data automatically. In a particular embodiment, the addition of a new portion of data corresponding with a shared tag may initiate the system automatically emailing one or more of the recipients of the shared email tag. The automatic email may alert the recipient that the new portion of data is available to the recipient.

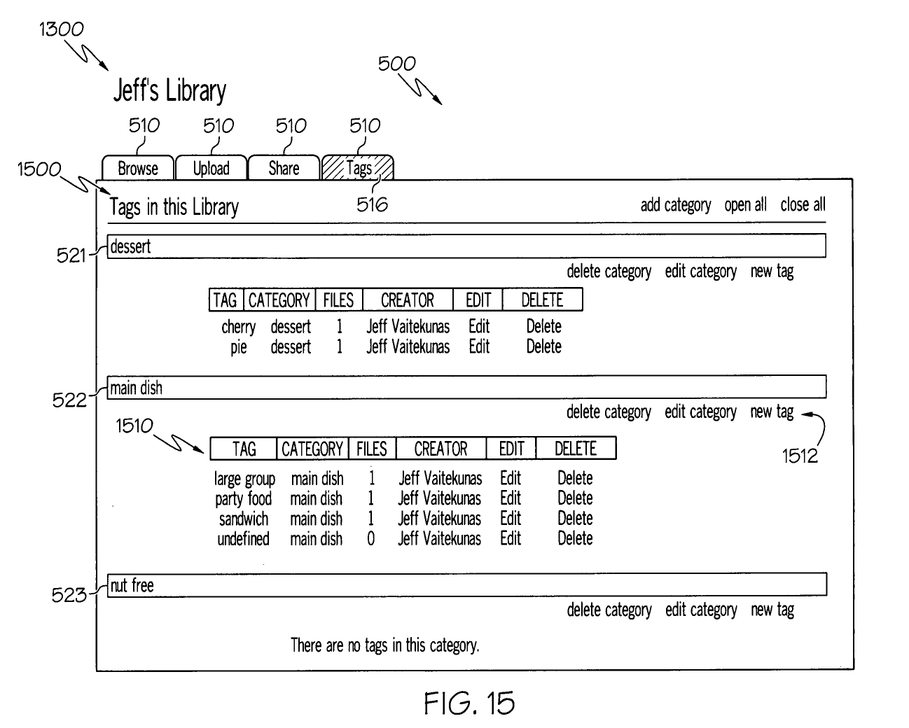

FIG. 15 is an example of the user interface 500 illustrating unstructured data having associated profiles used to manage the unstructured data in accordance with embodiments of the present invention. The tabs 510 identify a tab 516 indicating, in the example illustrated in FIG. 15, operations available to manage tags associated with unstructured data. A tags window 1500 illustrates the dessert category 521, the main dish category 522, and the nut free category 523, which are expanded to identify individual tags within the tags 521, 522, 523. For example, a tag group 1510 illustrates the tags associated with the main dish category 522. The tag group 1510 may include, for example, tag names, associated categories, number of files associated with each tag, creation information, on one or more soft buttons to perform tasks such as editing and/or deleting, or other desired actions. A group task list 1512 may be provided to perform operations on the tag group 1510, such as group deletion, group editing, tag creation, or other desired action.

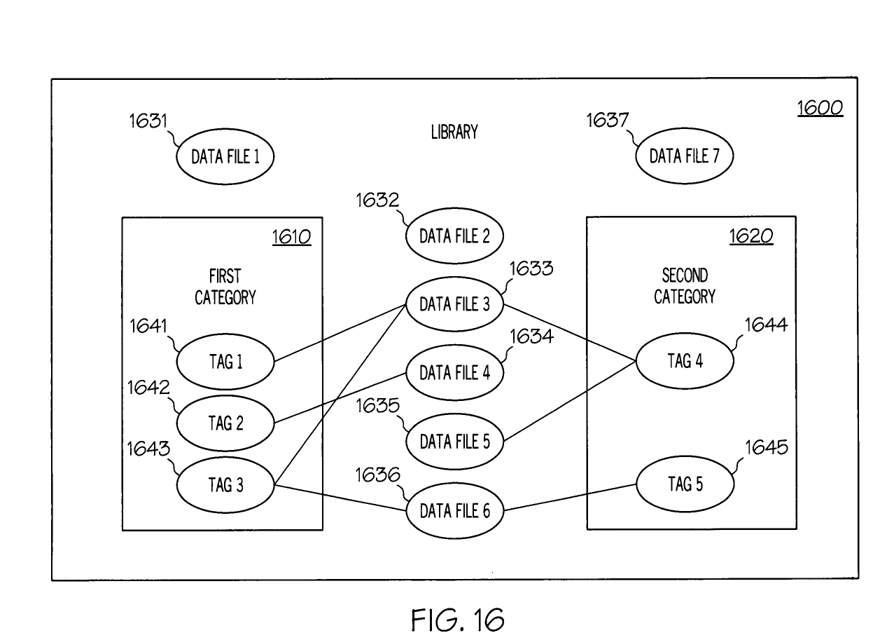

FIG. 16 is a block diagram of an embodiment illustrating managing unstructured data in accordance with embodiments of the present invention. A library 1600 is illustrated containing a first data file 1631, a second data file 1632, a third data file 1633, a fourth data file 1634, a fifth data file 1635, a sixth data file 1636, and a seventh data file 1637. A first category 1610 is associated with a first tag 1641, a second tag 1642, and a third tag 1643. A second category 1620 is associated with a fourth tag 1644, and a fifth tag 1645. As is illustrated in FIG. 16, any one or more data files may be associated with any one or more tags within any one or more categories. For example, a line drawn between a tag and a data file in FIG. 16 may illustrate an association between that tag and that data file.

Referring now to FIGS. 1 through 16, a non-exhaustive, non-limiting series of examples are provided below of embodiments of management of unstructured data in accordance with the present invention. In an example embodiment, profiles may be used to communicate with customers by storing and categorizing all the information for a particular client in one place. Data for particular clients may be labeled by project, people, topic, task, or whatever label is desired, including, but not limited to: keyword, key phrase, access authorization, expiration date, corroboration key, document history, file type, file size, revision tracking or other user-defined or system defined label. In another example, documents may be shared with a committee. A data management system in accordance with the present invention may keep a library of files that may be uploaded, downloaded, checked out, checked in, accessed, read, and edited. Access and editing permission may be controlled on a case-by-case basis.

For example, coordination of a project may be improved using a profile based data management system. Users may set up project names, vendors, cities, and more as labels for files. With a few clicks, users can assign labels to the files as they email them to one another and “CC” the system. The result: a library of project-related content, including emails and attachments, that is always up to date and perfectly organized. For purposes herein, the term email is used herein to generally refer to any electronic message and/or messaging service such as, for example SMS messaging, instant messaging (such as, AIM, ICQ, MSN), electronic mail messaging, Twain, HTTP, SMTP, POP3, or the like.

Profiles in accordance with the present invention may be used to manage email as unstructured data, for example to find a particular email that was associated with a profile. In one embodiment, plain text within email may be used to initiate creation of a profile associated with the email. The profile may be used to find the email at a later date. For example, a trigger such as one or more recipient names, sent to names, subject line phrases, text within the email, or other trigger words or phrases may be used to initiate creation of a profile associated with the email. In a particular example, a trigger word or phrase in an email my trigger the creation of a profile to associate with the email. The profile may be tagged with, for example, a tag for each recipient of the email. At a later date, a tag search on each individual would result in the email being identified in the search.

In a further example embodiment of using a profile to organize data, profile can be used with big files. For example, if there is a need to share a big file, such as a high-resolution graphic, or a video clip that's too big for email, a profile may be used in accordance with the present invention to label it and upload it. Colleagues may then be sent an email with a link, and everyone desired gets fast access. In a further example, a preview capability may be provided such that colleagues may preview the file before committing to a lengthy download, such as by, for example, viewing the first page, first image, or other portion of the data.

In a further example embodiment of using a profile to organize big files, a profile may be used in accordance with the present invention to preview the contents of the big file before uploading or downloading it. Previewing the file's contents using the profile allows a user to make a decision on whether to commit upload or download time to the profile's associated data.

In still a further example embodiment of using a profile to organize revisions and editing, a profile based data management system can be used to collaborate on a document. Instead of emailing versions and iterations around in circles, multiple authors can check files in and out in order to edit them, reducing confusion, rewrites, and overwrites. Users may keep track of important changes to files. Users can select files or labels to watch. Email notifications can be sent to users when a file has been uploaded, downloaded, edited, deleted, checked in or out. Selecting labels to watch allows users to be notified when a new file is added under a specific label or when the label information has changed. Account owners may have the ability to check back in any file.

In a further example embodiment of using a profile to manage unstructured data, a profile may be used to access files from anywhere, such as a user's home, a customer's office, the airport, the hotel, multiple business locations, or other location. Only a web browser and an Internet connection is needed. If a user has more than one computer, he doesn't need to worry about accidentally forgetting or overwriting a file. Further, the profile based data management system may be used with redundant servers to reduce lost data in the case of system failures. For example, one server may reside inside a firewall of an entity, and a redundant system may be securely linked for automated backups. The profile label for revision tracking may be used to only backup data that is new, or that has been updated since the last backup.

A profile may be used to search for files or other portions of data by any combination of labels such as may be user defined and/or system defined within a profile. Labels may be descriptive titles that administrators manage, for example. Label classes may be the top-level labels that other labels may be grouped under. A label class could be “document type”, which could contain the labels “budget”, “proposal”, “project plan” and “policies”. Label Groups may be defined that are special labels that contain any number of other labels and provide a quick way of adding several commonly used labels to a file at once. For example, a label class may be the category of all labels that are system generated versus user generated. In a particular embodiment, a label class may be all data files that have no tags associated with the data. This class may be searched to identify non-tagged data within the system, for example.

Results from profile searches may be sorted by date, name and file type similarly to folder-based systems. Recent files may appear in an alternative color, as may files that are currently checked out. Users may check out/in, delete, assign labels or view the details of more than one file at once. In an example embodiment, users may track files in their “library.” When a file is modified, the user may receive an email and link to download the updated version. Email reminders may be sent to users who don't check files back in after a designated time. Users can choose to be updated of each change immediately or receive a daily digest of all changes made to the system that day.

In accordance with a further embodiment of using a profile to manage unstructured data, labels may be managed. Labels may be added, edited and deleted. Libraries, tags, labels and label categories can also be merged or split and moved from one to another. For example, when a tag is edited the change may be reflected in the system and all files will show the updated information. When tags are deleted they may be automatically removed from all files and groups. Tags may also be archived to manage older or no longer used tags. Archived tags may be reactivated, and will still show up in groups they are associated with.

In accordance with a particular embodiment of using a profile to manage unstructured data, profiles may be created having a hierarchy of libraries, categories, and tags, useful as labels in accordance with the present invention. This structure may have, for example, a one to one to many data structure. Many tags may be assigned to unstructured data within a category, which is one of many categories assigned to a library. This structure is an intuitive structure that may be used to take advantage of the profile in a data management system in accordance with the present invention. For example, a library may have the name of recipes, a category in the recipe library may be desserts, and tags in the dessert category may include chocolate, no nuts, lactose free, glutin free, “Aunt Alice's recipes”, ingredients, and other tags of interest to the user. A user, for example, may select tags of ingredients available along with allergies and sensitivities, and get a list of appropriate recipes.

In embodiments of the present invention, tags may be organized in an accordion like structure. One example of a tag accordion is a set of related tags with corresponding weights, the tags capable of expanding and contracting as desired for a particular user interface. The weights may be represented, for example, using font sizes or other visual clues. A tag (or weighted list in visual design) is a visual depiction of a label. Tags are typically listed alphabetically, and tag frequency is typically shown with font size or color. Thus, finding a tag by alphabet and by popularity are both possible. For example, the tag's size may represent the number of items to which a tag has been applied, as a presentation of each tag's popularity, where larger tags represent the quantity of content items in that category. The tags may appear in alphabetical order, in a random order, they can be sorted by weight, or have other desirable ordering. For example, it is possible to cluster the tags semantically, so that similar tags will appear near each other. Further, heuristics may be used to alter the appearance of the tag.

A number of the examples presented herein involve block diagrams illustrating functional blocks used for managing unstructured data in accordance with embodiments of the invention. It will be understood by those skilled in the art that there exist many possible configurations in which these functional blocks may be arranged and implemented. The examples depicted herein provide examples of possible functional arrangements used to implement the approaches of the invention.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features.

Various modifications and additions can be made to the embodiments discussed hereinabove without departing from the scope of the present invention. Accordingly, the scope of the present invention should not be limited by the particular embodiments described above, but should be defined only by the claims set forth below and equivalents thereof.

What is claimed is:

1. A method in a networked computing system for a user to manage unstructured data, comprising:
providing a portion of data within a client in the networked computing system;
creating a profile associated with the portion of data, the profile comprising a first tag, and a user identifier;
transmitting the portion of data and the profile from the client to a server in the networked computing system;
automatically storing the portion of data and the first tag into a data structure on the server in response to receipt of the portion of data and the profile by the server;
updating the data structure in response to the user altering the first tag; and
identifying the portion of data in response to a query by the user seeking data associated with the first tag.

2. The method of claim 1, wherein transmitting the portion of data and the profile from the client to the server in the networked computing system comprises automatically transmitting any portion of data identified in the client if the portion of data is associated with the profile.

3. The method of claim 1, wherein transmitting the portion of data and the profile from the client to the server in the networked computing system comprises automatically transmitting any file attached to an electronic message if the electronic message is associated with the profile.

4. The method of claim 1, wherein transmitting the portion of data and the profile from the client to the server in the networked computing system comprises automatically transmitting any file attached to an electronic message if the electronic message comprises a trigger.

5. The method of claim 1, wherein the profile further comprises a list of approved users, the method comprising enabling access to the portion of data by each user in the list of approved users.

6. The method of claim 1, wherein transmitting the portion of data and the profile from the client to the server in the networked computing system comprises automatically transmitting any file attached to an electronic message if the electronic message comprises the profile, and wherein automatically storing the portion of data and the profile into the data structure on the server comprises updating the profile by adding a recipient list of the electronic message as a second tag.

7. The method of claim 1, wherein automatically storing the portion of data and the profile into the data structure on the server comprises creating a URL associated with the portion of data, and wherein identifying the data structure as associated with the tag comprises identifying the URL.

8. The method of claim 1, wherein the profile comprises a second tag selected from the list consisting of a keyword, key phrase, access authorization, expiration date, document history, file type, file size, and revision tracking.

9. A networked computing system for a user to manage unstructured data, the system comprising:
a client configured to provide a portion of data, and to associate the portion of data with a profile, the profile comprising a first tag, and a user identifier; and
a server communicatively coupled to the client, the server configured to receive the portion of data and the profile from the client, and to automatically store the portion of data and the first tag into a data structure on the server in response to receipt of the portion of data and the profile by the server, the server further configured to update the data structure in response to the user altering the first tag, and to identify the portion of data in response to a query by the user seeking data associated with the first tag.

10. The system of claim 9, wherein the client is further configured to automatically transmit, to the server, any portion of data identified in the client if the portion of data is associated with the profile.

11. The system of claim 9, wherein the client is further configured to automatically transmit, to the server, any file attached to an electronic message if the electronic message comprises the profile.

12. The system of claim 9, wherein the client is further configured to automatically transmit, to the server, any electronic message and its associated profile if the electronic message comprises a trigger.

13. The system of claim 9, wherein the profile further comprises a list of approved users, the server further configured to enable access to the portion of data by each user in the list of approved users.

14. The system of claim 9, wherein the server is further configured to receive any file attached to an electronic message if the electronic message comprises the profile, and to update the profile by adding a recipient list of the electronic message as a second tag.

15. The system of claim 9, wherein the profile further comprises a list of approved users, and wherein the server is further configured to create a URL associated with the portion of data, and identify the URL in response to a query by an approved user identified in the list of approved users, the approved user seeking data associated with the first tag.

16. The system of claim 9, wherein the profile comprises a second tag selected from the list consisting of a keyword, key phrase, access authorization, expiration date, document history, file type, file size, and revision tracking.

17. A networked computing system for a user to manage unstructured data, the system comprising:
means for providing a portion of data within a client of the networked computing system;
means for creating a profile associated with the portion of data, the profile comprising a first tag and a user identifier;
means for transmitting the portion of data and the profile from the client to a server in the networked computing system;
means for automatically storing the portion of data and the first tag into a data structure on the server in response to receipt of the portion of data and the profile by the server;
means for updating the data structure in response to the user altering the first tag; and
means for identifying the portion of data in response to a query by the user seeking data associated with the first tag.

18. The system of claim 17, comprising means for automatically transmitting any portion of data identified in the client if the portion of data is associated with the profile.

19. The system of claim 17, comprising means for enabling access to the data structure by each user in a list of approved users.

20. A computer-readable medium having computer-executable instructions for managing unstructured data, the computer-executable instructions performing steps comprising:
providing a portion of data within a client in a networked computing system;
creating a profile associated with the portion of data, the profile comprising a first tag, a category label, a library label, and a user identifier;
transmitting the portion of data and the profile from the client to a server in the networked computing system;
automatically storing the portion of data and the first tag into a data structure on the server in response to receipt of the portion of data and the profile by the server;
updating the data structure in response to the user altering the first tag; and
identifying the portion of data in response to a query by the user seeking data associated with the first tag.
